(19) United States
(12) Patent Application Publication
(10) Pub. No.: US 2025/0135655 A1
(43) Pub. Date: May 1, 2025

(54) HUMAN-ROBOT INTERFACE SYSTEM WITH BIDIRECTIONAL HAPTIC FEEDBACK

(71) Applicant: Intel Corporation, Santa Clara, CA (US)

(72) Inventors: David Gonzalez Aguirre, Hillsboro, OR (US); Javier Felip Leon, Hillsboro, OR (US); Javier Felix Rendon, Zapopan (MX); Roderico Garcia Leal, Zapopan (MX); Julio Zamora Esquivel, West Sacramento, CA (US)

(21) Appl. No.: 19/004,290

(22) Filed: Dec. 28, 2024

(51) Int. Cl. B25J 13/02; B25J 9/16

(52) U.S. Cl. CPC B25J 13/025; B25J 9/161

(57) ABSTRACT

A bidirectional haptic feedback system, including: a flexible membrane configured to be mounted on a handheld controller; sensor-actuator units arranged on the flexible membrane, the sensor-actuator units respectively including a damping mechanism configured to mechanically isolate vibrations between adjacent sensor-actuator units; a control system configured to: generate vibration signals within selected frequency bands within a proximity to a natural resonant frequency range of the sensor-actuator units to drive the actuators of the sensor-actuator units to deliver haptic feedback to a user based on a state of the robot; simultaneously detect user grasp contact and pressure through analysis of back electromotive force (EMF) signals generated by the sensor-actuator units; and adjust robot control parameters dynamically in response to the detected grasp contact and pressure.

### BACKGROUND

Collaborative robots are revolutionizing automation across various sectors and regions by enabling the seamless “zero-code integration of human task knowledge” through extended reality (XR) demonstrations for behavior cloning. These approaches are critical to robotic task representation methodologies, including end-to-end deep reinforcement learning, behavioral trees, and state machines. Recent advancements demonstrate the feasibility and value of generating and validating reliable robot sensory-motor behaviors in real-world environments with only a few multimodal demonstrations. However, current solutions face significant challenges in effectively capturing high-quality multimodal demonstrations via XR interfaces incorporating force-haptic feedback, leaving this potential largely unexplored.

### BRIEF DESCRIPTION OF THE FIGURES

FIG. 1 illustrates a block diagram of a bidirectional haptic feedback system in accordance with aspects of the disclosure.

FIGS. 2A-2C illustrate schematic diagrams of a handheld controller in accordance with aspects of the disclosure.

FIG. 3 illustrates a taxonomy diagram of bidirectional tactile haptic feedback in human-robot collaboration in accordance with aspects of the disclosure.

FIG. 4 (4A-4C) illustrates a schematic diagram of a bidirectional haptic feedback system in accordance with aspects of the disclosure.

FIGS. 5A-5C illustrate schematic diagrams of membrane shape and sensor-actuator distribution in accordance with aspects of the disclosure.

FIG. 6 illustrates a schematic diagram of a linear resonant actuator in accordance with aspects of the disclosure.

FIG. 7A illustrates a graph of typical resonance frequencies.

FIG. 7B illustrates a graph of an LRA specification with rapid decay in accordance with aspects of the disclosure.

FIG. 8 (8A-8B) illustrates a schematic diagram of stimulation signals, back electromotive force (EMF), and decoupling in accordance with aspects of the disclosure.

FIG. 9 (9A-9B) illustrates a calibration and runtime algorithm in accordance with aspects of the disclosure.

FIG. 10 illustrates a schematic diagram of teleoperation haptic stimulation for force and contact in accordance with aspects of the disclosure.

FIG. 11 illustrates a schematic diagram of neuro-amplitude modulation and inference training in accordance with aspects of the disclosure.

### DETAILED DESCRIPTION

The present disclosure is directed to bidirectional haptic feedback for immersive cobot interfacing in human robot collaboration.

Current technologies lack model-agnostic, hand-held devices that are compact and cost-effective while enabling dual human-and-robot XR feedback. Existing solutions fail to effectively capture high-quality multimodal demonstrations through XR interfaces with integrated force-haptic signals, leaving critical challenges unaddressed.

The aspects disclosed herein overcome the limitations of prior systems by introducing generic sensory-actuator membranes for XR controllers. These membranes simultaneously stimulate and detect contact points and forces applied by both the user and the robot's end-effector, including force, torque, and tactile cues, during task demonstrations and teleoperation. The disclosed aspects enable real-time vibration feedback, modulated dynamically according to the task's state. This allows the disclosed system to map dynamic and heterogeneous cues-such as contact, force, position, orientation, and payload-into time-varying vibration patterns for the user and continuous control targets for the robot. These features are useful for teleoperation and automation in vision-force tasks, where precise interactions are required to intuitively develop complex robotic programs.

The handheld controller described herein is optimized for low cognitive load interactions, offering users detailed feedback that enhances force closure control and other advanced applications. Of the various haptic feedback channels available, mechanical vibrations generated by LRA units are particularly effective in stimulating the Pacinian corpuscles and Ruffini endings in the hand.

### I. Overview

### A. Bidirectional Haptic Feedback System 100

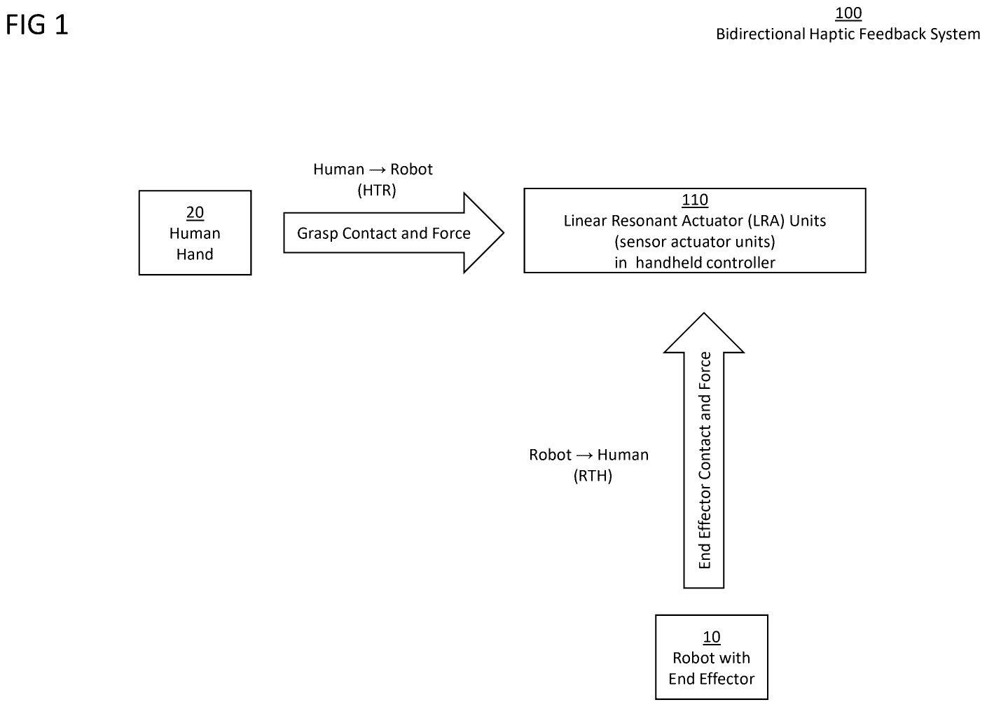

FIG. 1 illustrates a block diagram of a bidirectional haptic feedback system 100 that enables bidirectional haptic feedback between a human hand 20 and a robot 10 with an end effector. The bidirectional haptic feedback system 100 provides both Human-to-Robot (HTR) communication, where grasp contact and force from the human hand 20 is transmitted to linear resonant actuator (LRA) units 110 (sensor actuator units), and Robot-to-Human (RTH) communication, where the end effector's contact and force information from the robot 10 is transmitted to the human hand 20 through the LRA units 110. The bidirectional haptic feedback system 100 enables low-latency haptic-tactile feedback that accurately detects and classifies user grasps by monitoring contact regions and force exerted upon sixteen sensing-acting regions, while simultaneously providing distinguishable robot-to-human stimulation interfaces.

### B. Handheld Controller 200

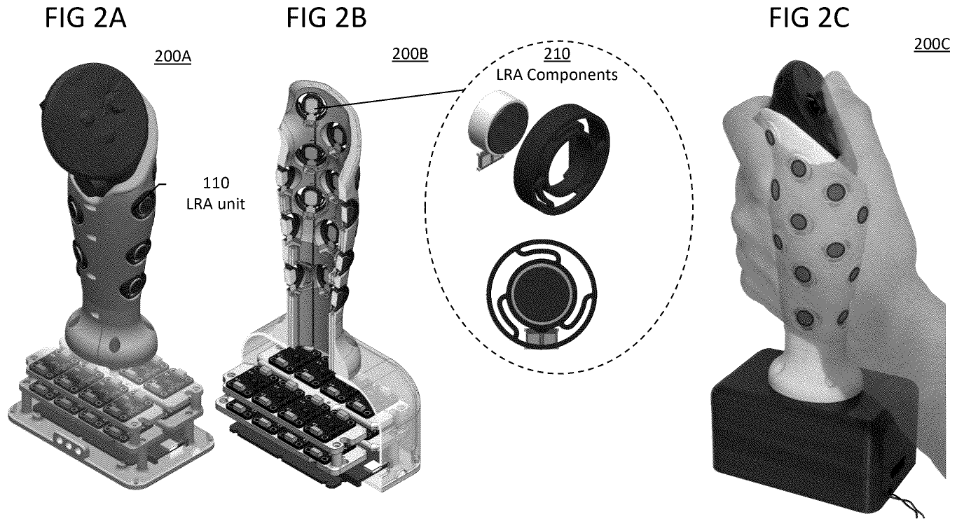

FIGS. 2A-2C illustrate schematic diagrams of a handheld controller 200 in accordance with aspects of the disclosure.

FIG. 2A shows an external view of the handheld controller 200A with multiple LRA units 110 arranged in a strategic pattern around its surface.

FIG. 2B shows an internal cross-sectional view of the handheld controller 200B revealing the placement and mounting of the LRA units 110 (sensor-actuator units), including their three-point contact decoupling mounting system (damping mechanism) that reduces mechanical vibration cross-talk between adjacent LRA units 110 through an S-formed damper that attenuates vibrations in the planar direction along the membrane. FIG. 2B also shows some of the LRA components 210 in detail, including the three-point contact decoupling mounting system. The handheld controller 200 features a soft-warping casing that strategically places the LRA units 110 for vibration control in both frequency and amplitude within a range of, for example, 50-230 Hz, allowing distinguishable haptic feedback patterns while simultaneously enabling force and contact sensing through the same LRA units 110.

FIG. 2C shows the handheld controller 200C being grasped by a human hand, illustrating the ergonomic design and strategic placement of the LRA units 110. The device features a soft-warping membrane made of, for example, thermoplastic urethane, that adapts to variable hand sizes while maintaining mechanical acuity. The LRA units 110 are distributed across the membrane surface according to the nerve density of the human hand's mechanoreceptors, with higher concentrations at the distal parts of the fingers where there is greater density of rapid adapting (RA) and slow adapting (SA) receptors. The placement of the sixteen LRA units 110 follows a parametric geometric model for stable grasp, considering a percentile distribution of human hands and optimizing contact area and comfort during grip. Again, each LRA unit 110 is mounted using a three-point contact decoupling system with an S-formed damper that reduces mechanical cross-talk between adjacent units while maintaining stable positioning. Of course the design is not limited to there being sixteen LRA units 110; there may be any number as suitable.

This handheld generic controller membrane integrates both sensor and actuator capabilities, enabling bidirectional, low-latency haptic feedback via wired and wireless connections. This functionality facilitates the detection of a user's grasp relative to contact points and measures the force exerted across sixteen regions of the hand. These capabilities significantly enhance expressive immersion during teleoperation and human-robot collaboration for task co-execution.

This sensing modality addresses challenges such as visual occlusion, workspace clutter, and the need for fine calibration (e.g., hand-eye coordination, 6D pose estimation, and contact deviations) by providing contact and force cues. Demonstrations captured via this interface are particularly well-suited for precise grasping and manipulation of variable, small, and fragile objects. This capability is critical for high-mix, low-volume XR-driven teleoperation in manufacturing—an area where such functionality remains unprecedented. The controller also features an ergonomic design, created using parametric modeling based on anthropometric data, to ensure maximum contact area and grip comfort for hands of all sizes.

### C. Bidirectional Haptic Feedback

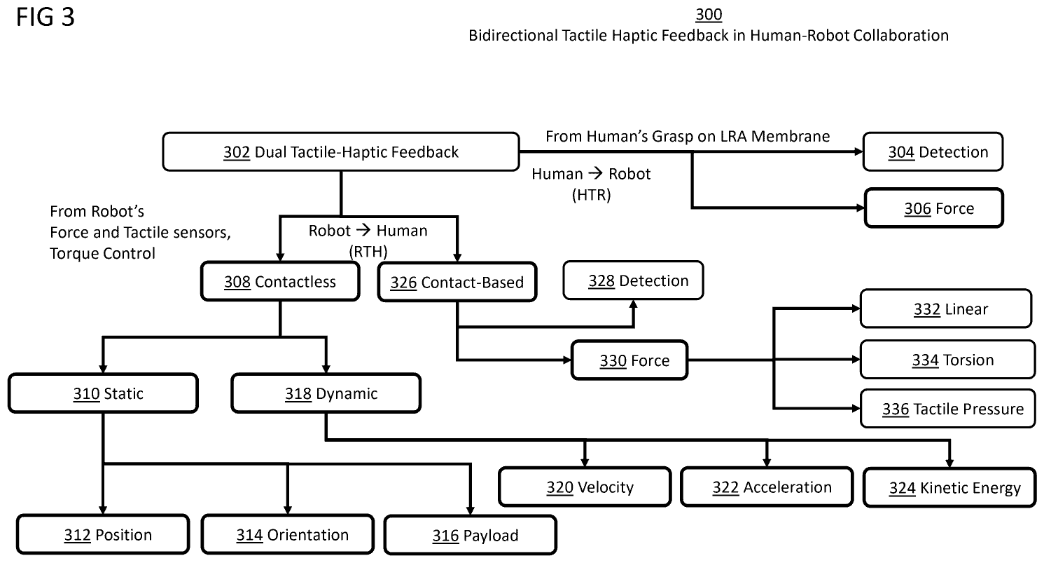

FIG. 3 illustrates a taxonomy diagram 300 of bidirectional tactile haptic feedback in human-robot collaboration, showing the various communication channels between the human operator and robot. The taxonomy diagram 300 of dual tactile-haptic feedback 302 includes two main branches: Human-to-Robot (HTR) communication and Robot-to-Human (RTH) communication. The RTH branch further subdivides into contactless feedback 308 and contact-based feedback 326 modes.

The contactless feedback 308 includes both static feedback 310 and dynamic feedback 318 subcategories. The static feedback 310 provides information about the robot's position 312, orientation 314, and payload capacity 316. The dynamic feedback 318 communicates velocity 320, acceleration 322, and kinetic energy 324 parameters to the human operator. This contactless feedback enables the bidirectional haptic feedback system 100 to warn operators about approaching workspace limits, excessive speed, or dangerous kinetic energy levels during operation through haptic vibrations, without requiring physical contact between the robot and its environment. The contactless feedback may also be based on the state of the robot for a contactless quantity measured by the robot, wherein the contactless quantity comprises kinetic energy, payload, proximity to a joint limit, graspability, or manipulability.

The contact-based feedback 326 transmits information about physical interactions, including detection of contact events 328, linear forces 332, torsional forces 334, and tactile pressure measurements 336 from the robot's end effector. The bidirectional haptic feedback system 100 can simultaneously process both contact-based feedback 326 and contactless feedback 308, allowing operators to receive comprehensive haptic information about the robot's state and its interaction with the environment through distinct vibration patterns generated by the LRA units 110.

The HTR branch captures the operator's grasp information, including contact detection 304 and force measurements 306, enabling natural and intuitive control of the robot through the handheld interface. This bidirectional feedback system operates in both simulated and real environments, with the controller's feedback patterns adapting based on the specific task being performed and the operator's actions.

### II. Bidirectional Haptic Feedback System 400

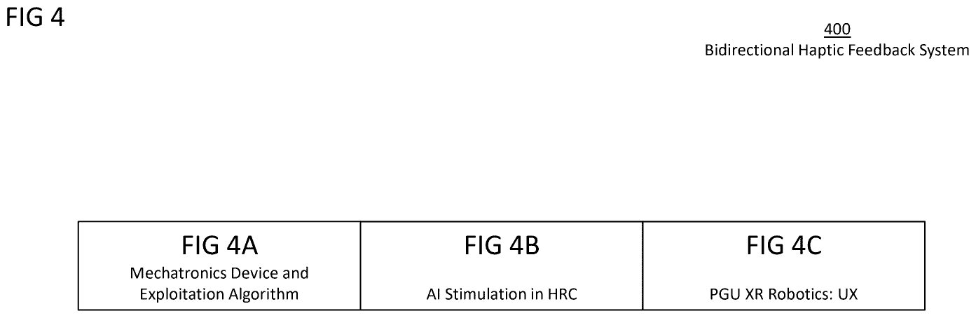

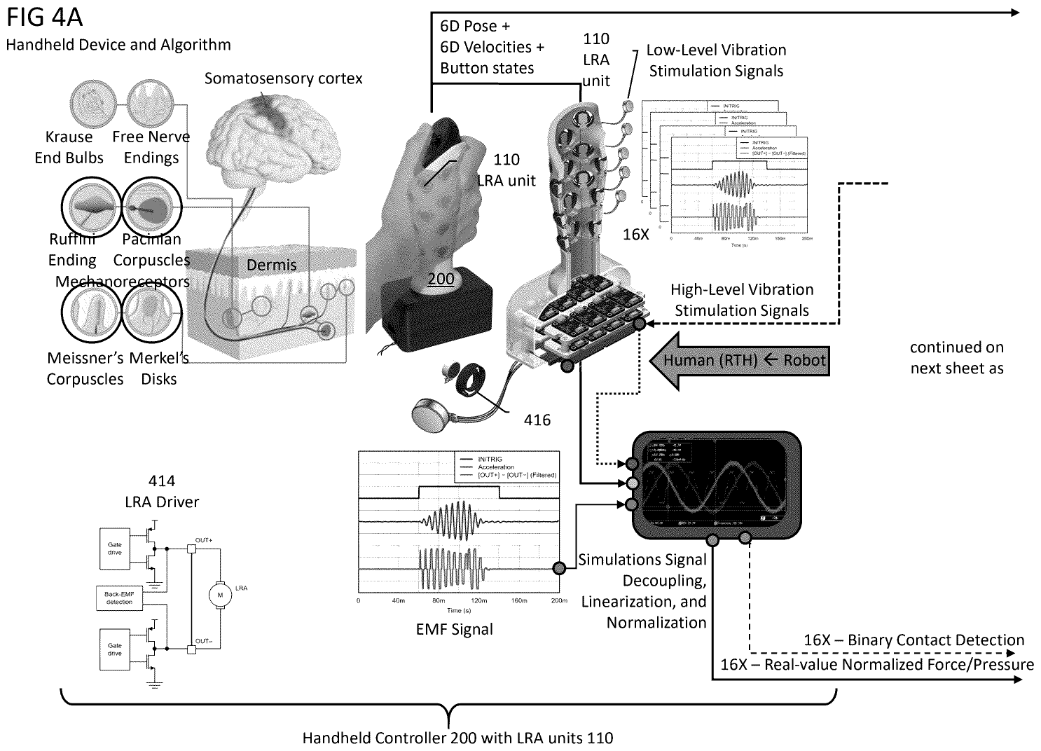

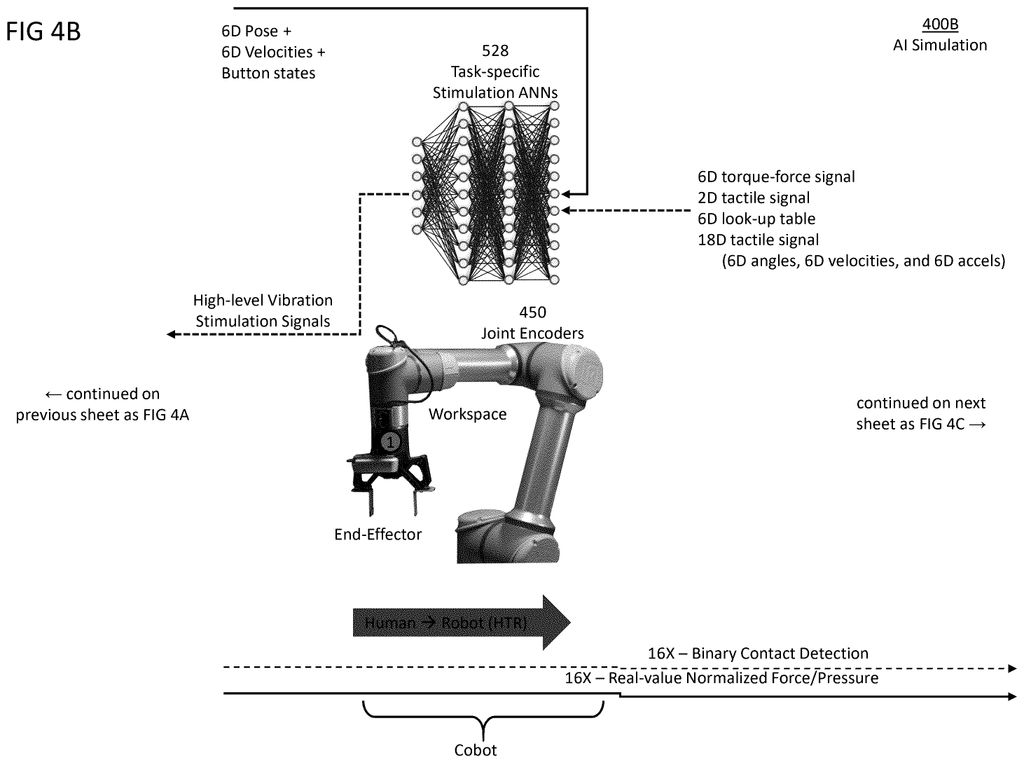

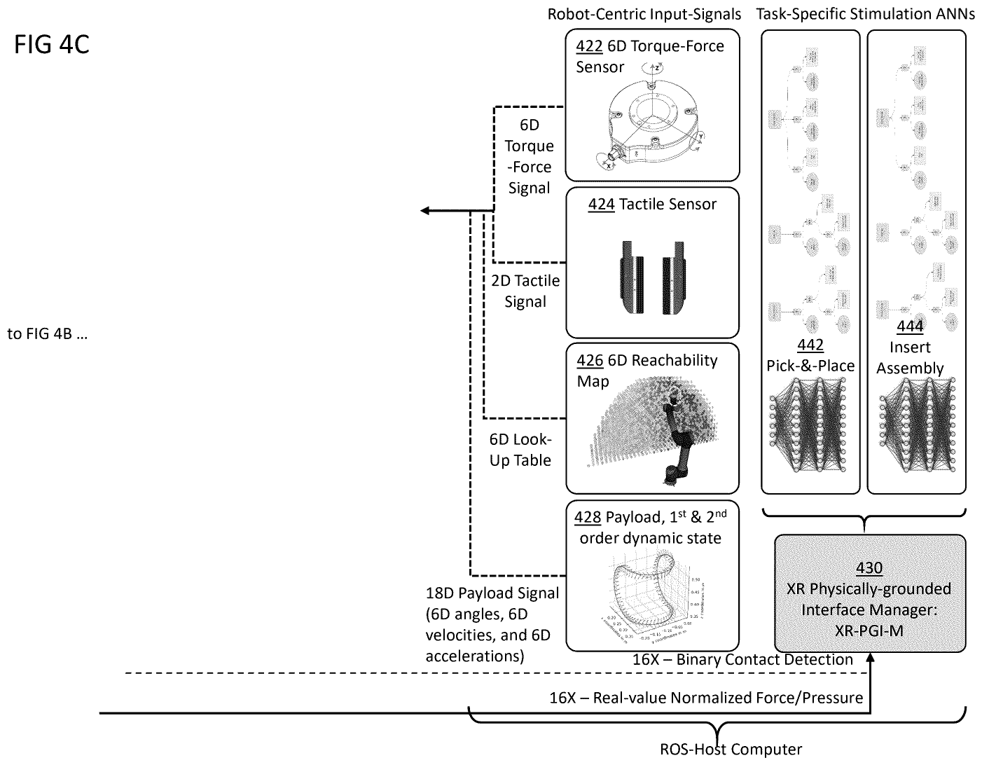

FIG. 4 (divided across three sheets labeled as FIGS. 4A-4C, respectively) illustrates a bidirectional haptic feedback system 400 in accordance with aspects of the disclosure. It depicts the distribution of human, robot, and membrane elements and highlights their integration for immersive cobot control.

FIG. 4A illustrates the handheld device 200, including a handheld controller with a membrane comprising sixteen LRA units 110 (sensor-actuator units). Each LRA unit includes an LRA motor, an LRA driver 414, and a three-point contact decoupling mounting system 416. The motors move linearly along an axis when voltage is applied, with positive voltage producing movement in one direction and negative voltage causing contraction in the opposite direction. The three-point mounting system 416 attenuates planar vibrations, minimizing mechanical cross-talk between adjacent LRA units.

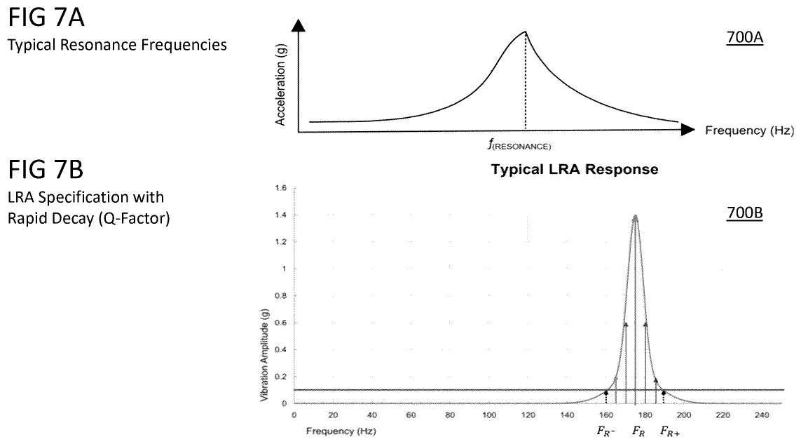

The LRA units 110 stimulate mechanoreceptors at varying frequencies and depths in the skin, generating multi-contact stimuli processed by the user's somatosensory cortex with low latency. Additionally, diverse regions on the membrane enable indirect measurement of contact and pressure applied by the user's hand through back electromotive force (EMF) feedback. By analyzing the input signals and output differences between the poles of the LRA coils, the system determines phase shift and amplitude attenuation, as illustrated in FIG. 7B. These metrics provide a detailed description of the pressure exerted on the LRA surface.

FIG. 4B illustrates the system's artificial intelligence module 400B for processing robot-centric input signals. FIG. 4C introduces the extended reality physically grounded interface manager (XR-PGI-M) 430. The system includes a six-dimensional (6D) torque-force sensor 422, tactile sensor 424, and joint encoder 450 (shown in FIG. 4C), which provide data to task-specific artificial neural networks (ANNs) 528. These ANNs generate both low-level and high-level vibration signals that are transmitted to the handheld device. The XR-PGI-M 430 evaluates the robot's operational state and execution context to select appropriate mapping schemes-linear, nonlinear, or neural network-based-depending on the task, such as memory insertion. This ensures the system produces task-specific haptic feedback patterns, delivered via the handheld device.

The robot senses forces and torques applied to the end-effector through a 6D sensor 422 on the wrist, while tactile sensors 424 measure contact interactions at the gripper. These combined signals reflect the robot's physical interaction with the environment, augmented by a reachability map 426, which indicates proximity to critical kinematic regions. Joint angles and their derivatives 428 provide additional real-time data about the robot's physical state.

Signals from the robot and the handheld device-including 6D pose, velocities, and button states—are flattened into an input vector. This vector is processed by a Deep Neural Network (DNN), which outputs thirty two real numbers representing amplitude and frequency values for each LRA unit 110. These sixteen phasors are transmitted as compressed IP packets to the microcontroller unit (MCU), which uses I2C communication to drive targeted stimulation signals.

The system enables bidirectional communication through back EMF measurements. By applying voltage to the LRA motors and analyzing the resulting EMF, the system infers contact forces and pressure exerted by the user's hand. The analysis, performed in the frequency domain, determines phase shifts and amplitude attenuation to quantify these forces.

### III. Mechatronic Device and LRA Unit (Sensor Actuator Unit) Algorithm (Further Details Related to FIG. 4A Described Above)

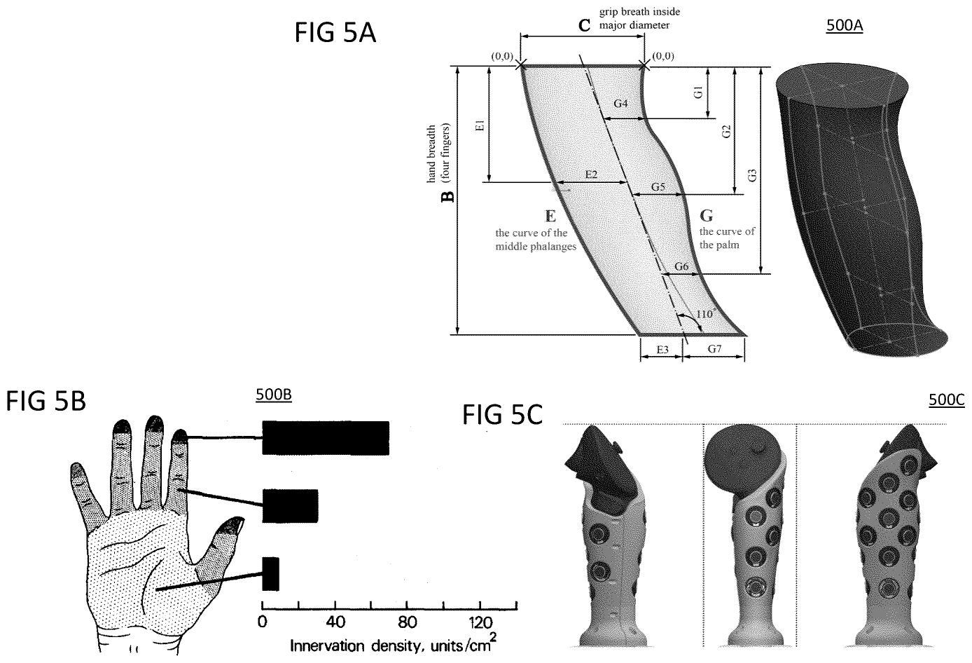

FIGS. 5A-5C illustrate the membrane shape and distribution of LRA units 110 of the handheld controller 200.

FIG. 5A shows a parametric geometric model 500A of the membrane shape, defined by grip breath inside major diameter C, hand breadth B, the curve of the middle phalanges E, and the curve of the palm G. The model 500A includes measurement points G1-G7 and E1-E3 that define the contours for achieving stable grasp across different hand sizes.

FIG. 5B depicts an innervation (nerve) density map 500B of the human hand, showing the distribution of mechanoreceptors measured in units per square centimeter. The density values range from 0 to 120 units/cm2, with higher concentrations shown in the fingertip regions. This biological mapping guides the strategic placement of the sixteen LRA units 110 to optimize tactile feedback sensitivity.

FIG. 5C shows three views 500C of the implemented membrane device with the distributed LRA units 110, indicated by circular markers. The placement of these LRA units 110 follows both the parametric geometric model for stable grasp and the innervation density distribution of mechanoreceptors in the human hand. This dual-factor approach ensures sufficient contact sensitivity while accommodating variations in user hand size, index finger position, and thumb state.

### A. LRA Unit 110 as Sensor Actuator Unit Principles and Signals

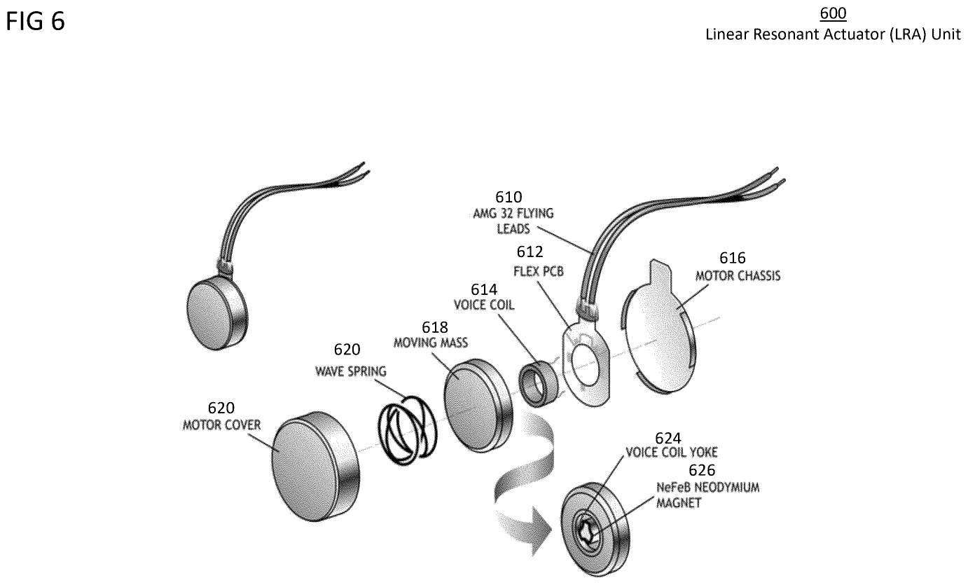

FIG. 6 illustrates a linear resonant actuator (LRA) unit 600 that generates an oscillating force along a single axis using AC voltage V(t) [symbol] R. The LRA 600 drives a voice coil 614 against a magnetic mass 618 connected to a wave spring 620. When driven at the spring's resonant frequency wo, the LRA unit 600 vibrates with a perceptible force. While the frequency and amplitude can be adjusted via the AC input voltage A(t)=|V(t)|, the LRA unit 600 must run near its resonant frequency, as

$$arg {max}_{k} \{ F [ k ] = \vert F ( {V}_{α} ( t ) ) \vert \} ≃ {ω}_{0} ,$$

for effective force generation. The voice coil 614 stays stationary, pressing against the moving mass 618 to produce vibration by displacing the moving mass 618 up and down against the wave spring 620. As shown, the LRA unit 600 also includes flying leads 610 connected to a flex PCB 612, which interfaces with a voice coil 614. A motor chassis 616 houses these components, while a motor cover 622 encloses the assembly. A voice coil yoke 624 and NeFeB neodymium magnet 626 complete the electromagnetic system.

FIG. 7A shows a graph 700A of typical resonance frequencies for the LRA unit 600, where the system can store and easily transfer energy. FIG. 7B depicts the LRA specification 700B showing a characteristic rapid decay (Q-Factor) behavior.

As a mass-spring electromechanics system, LRA units 600 have a matching temporal or spatial period of oscillation. The natural resonance frequency curve and peak wo can be calibrated off-line, as shown in FIG. 7A. This frequency denotes the point at which the system can store and easily transfer energy. FIG. 7B shows typical (across LRA models) and real (model) resonance curves of LRA units 600. Due to the small mass and oscillation range, these devices expose a high Q-factor or resonance-dropping behavior.

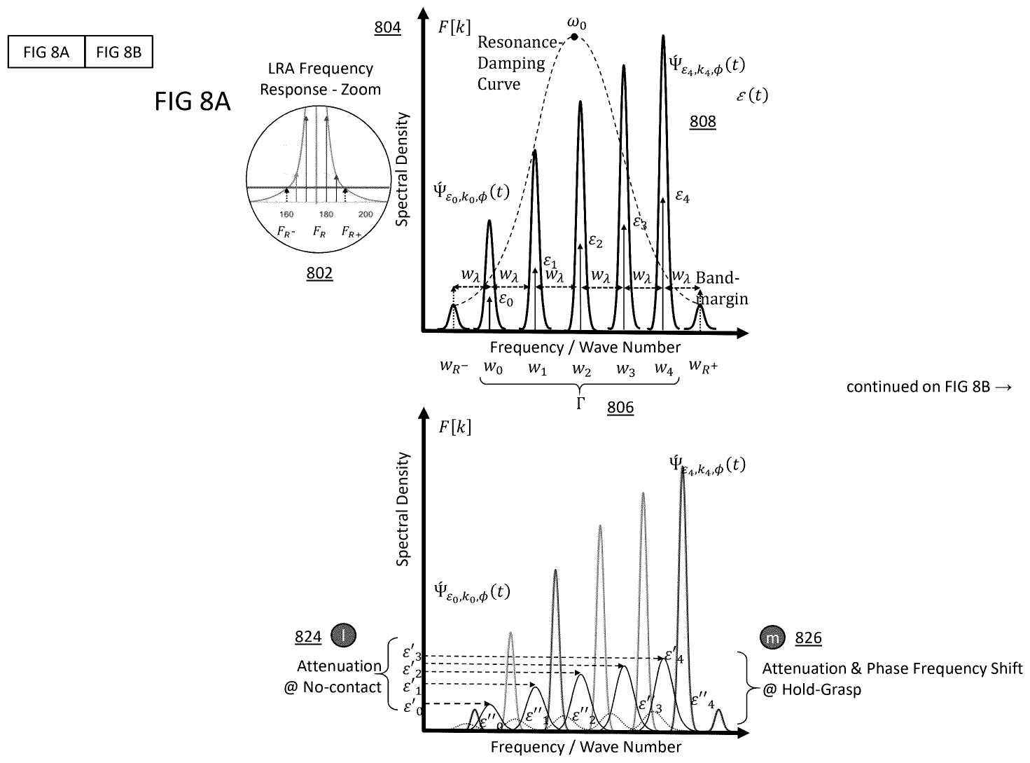

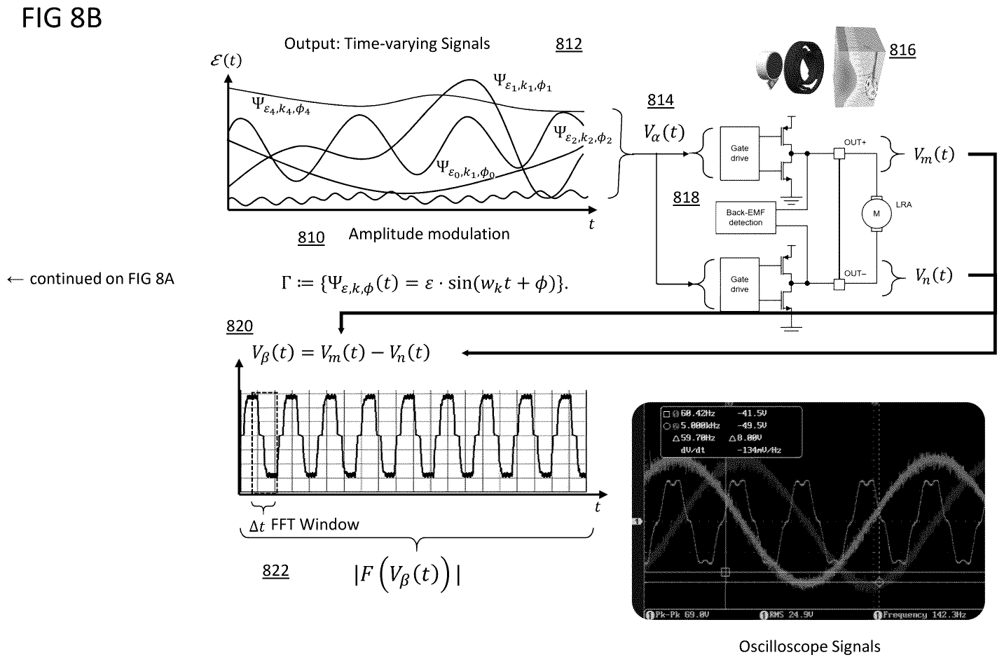

An aspect of this disclosure focuses on simultaneously stimulating the user's hand while detecting contact and pressure, without imposing restrictions on the shape or modulation of V_{α}(t). To achieve this, the stimulus (message-refence) signal V_{α}(t) is extracted from the noisy counter-electromotive force-signal V_{β}(t)=Vₒᵤₜ(t)−Vᵢₙ(t) of the same LRA unit 110. Additionally, given the damping effects of tissue and the mounting on a flexible membrane, selecting appropriate amplitudes and stimulation frequencies is a factor. These parameters align with the characteristic (quasi-Gaussian) decay relative to resonance, as shown in FIG. 8B. Specifically, the Fourier transform F(V_{α}(t)) [symbol] F(k), expressed in terms of its spectral density F[k]:=|F(k)|, reveals distinguishable local maxima. These maxima have sufficiently large inter-modal margins to reliably identify modal peak frequencies as

$$Θ := \{ \vert F [ {k}_{i} ] \vert F [ {k}_{i - 1} ] < \hat{F} [ {k}_{i} ] > F [ {k}_{i + 1} ] \} .$$

To obtain an identifiable set of local maxima in a narrow-band noisy channel, a reduced set of harmonic stimulation functions need to be created as

$$Γ := \{ {Ψ}_{ε , k , ϕ} ( t ) = ε \cdot sin ( {w}_{k} t + ϕ ) \} .$$

where wₖ represents the angular frequency k, and ϕ denotes the phase. The phase is relevant in identifying modes for the overall signal propagation period across stages, including end-to-end reaction latency across PC, MCU, driver, LRA, and membrane-hand coupling. The cardinality of Γ is constrained by the lower and upper resonance frequencies F_{R}_{^{−}} and F_{R}_{⁺}, respectively, as shown in FIG. 7B. This set is further reduced by the quantization resolution used in spectral density computations, resulting in the addition of a saliency margin. An example of this adjustment is shown for a vibration amplitude 0.1 g in FIG. 7B, which further narrows the band [F_{R}_{^{−}},F_{R}_{⁺}]. Considering these constraints, and to ensure reliable detection of phase shifts and variable attenuation of the harmonic Ψ_{ε,k,ϕ}(t), the stimulation set's cardinality is defined by:

$$\vert Γ \vert = ⌊ \frac{{F}_{{R}^{+}} - {F}_{{R}^{-}}}{{w}_{λ}} ⌋ ,$$

where the w_{λ} represents the band margin between harmonics Ψ_{ε,k,ϕ} to be indefinable despite channel and potential embedded compute limitations between host and MCU.

### B. LRA-EMF Contact Detection, Force Decoupling, Linearization, and Normalization

FIG. 8 (divided across two sheets labeled as FIGS. 8A-8B, respectively) illustrates the methods and principles for LRA-EMF contact detection, force decoupling, linearization, and normalization.

Reference numeral 802 shows the frequency band where all stimulation signals produce perceptible vibrations on the user's hand. At reference numeral 804, the spectral density of ideal output harmonic stimulations Ψ_{ε,k,ϕ} is compared with their reconstructed version \acute{Ψ}_{ε,k,ϕ}, emphasizing the importance of designing the set Γ with appropriate cardinality and frequencies wₖ, as well as an antialiasing margin w. This design allows for modulating the amplitudes εᵢ(t) to stimulate the user's hands using separable base frequencies, as depicted at reference numeral 806.

Reference numeral 808 demonstrates how the time-varying εᵢ(t) amplitudes encode vibration messages over time, while at reference numeral 810, the generation of these action-message signals are generated via a deep neural network (DNN), as detailed in the subsequent section. The passage of a single harmonic signal to the motor driver is shown at reference numeral 812, and at reference numeral 814, the transformation of the amplitude-frequency pairs are transformed into positive and negative voltages in the respective gate drivers to produce vibration.

In closed-loop mode, shown at reference numeral 818, the driver samples the EMF to maximize force output. In free mode, at reference numeral 820, the voltage difference between the motor poles, represented as V_{β}(t)=Vₘ(t)−Vₙ(t), indirectly reflects the dynamic damping of the medium, such as hand contact and applied pressure on the surface of the LRA unit 110.

Reference numeral 822 illustrates how the EMF signal V_{β}(t), transformed into its spectral density representation, enables the identification of modal peaks (modes) based on their peak positions in wave number k and their relative amplitudes within the band. This is expressed as ϕᵢ(t, t′)=ε′ᵢ(t)/εᵢ(t′), where the attenuation ratio ϕᵢ(t, t′)<1 signifies energy absorption due to the mechanical states of the LRA unit 110. The time difference δtᵢ=(t−t′) represents the system's latency, which is measured during calibration under two hand-holding states: (l) no-contact run-time and (m) hold-grasp and strong press states.

The dual functionality of serving as both a sensor and an actuator is enabled through advanced stimulation feedback analysis using Electromotive Force (EMF) or similar physical-signal processes. This aspect is not confined to handheld controllers and is applicable to a side range of haptic interfaces. The principles and methods outlined herein have broad applications across various industries, including but not limited to medical devices, consumer electronics, automotive systems, and other human-haptic applications.

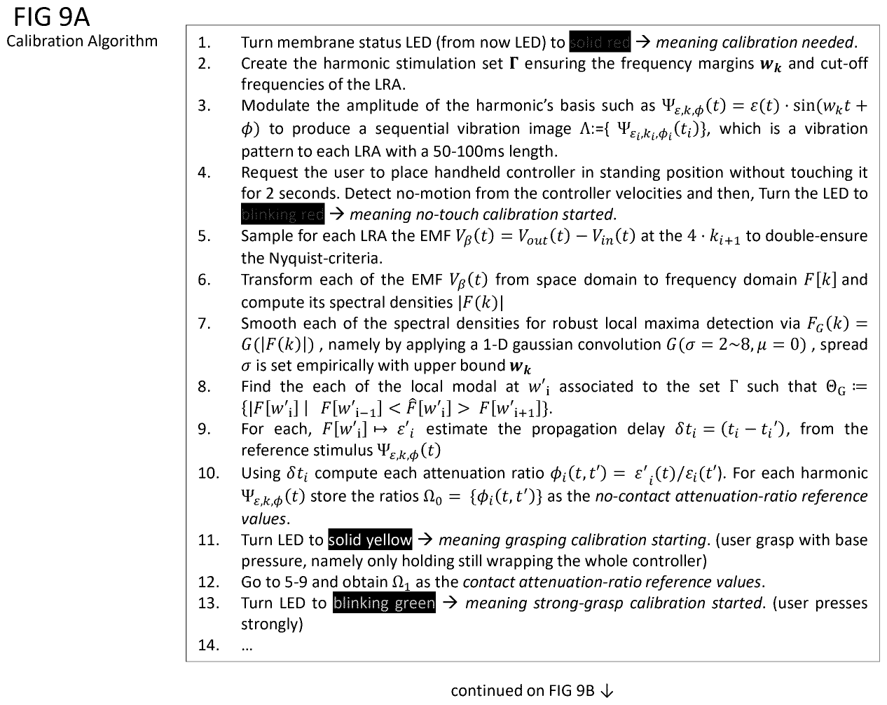

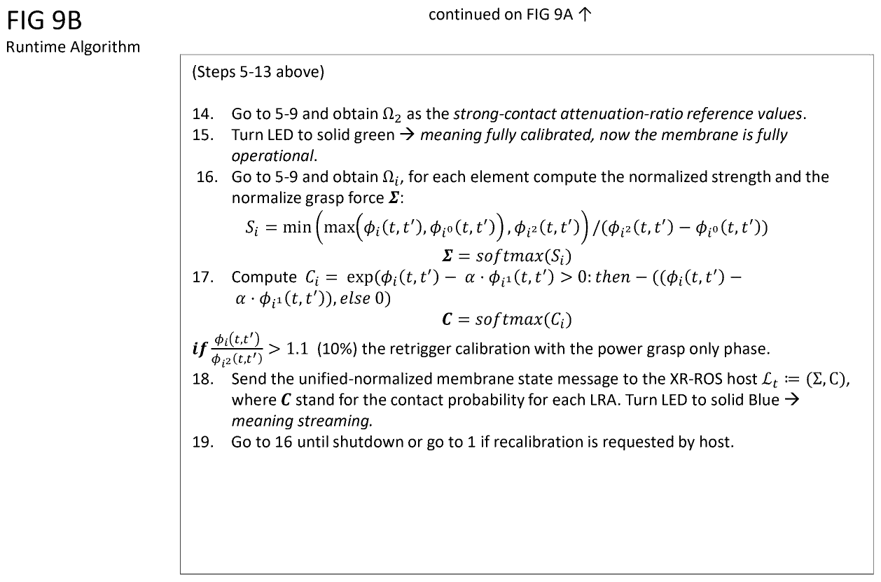

FIG. 9 (divided across two sheets labeled as FIGS. 9A-9B, respectively) illustrates a calibration and runtime algorithm 900 in accordance with aspects of the disclosure.

FIG. 9A shows a calibration algorithm 900A for the bidirectional haptic feedback system 100. During calibration, the system establishes baseline measurements for three distinct states: no contact, base contact pressure, and strong contact pressure. The system uses harmonic stimulation patterns with specific frequency margins to generate vibrations through LRA units 110, while simultaneously measuring back electromotive force (EMF) to detect contact pressure.

The calibration algorithm 900A uses LED indicators to guide users through each phase, starting with a no-contact measurement where the controller is held stationary without being touched. The system then measures base contact pressure when the user holds the controller normally, and strong contact pressure when maximum force is applied. For each phase, the system samples EMF signals, transforms them to the frequency domain, and computes spectral densities to establish reference attenuation ratios.

FIG. 9B shows a runtime operation 900B, during which the system monitors EMF signals from each LRA unit 110, comparing current attenuation ratios against the calibrated reference values to simultaneously provide haptic feedback while measuring user grip force. This bidirectional capability enables the system to both stimulate the user's hand with precise vibration patterns and detect the user's grasp pressure without one signal interfering with the other.

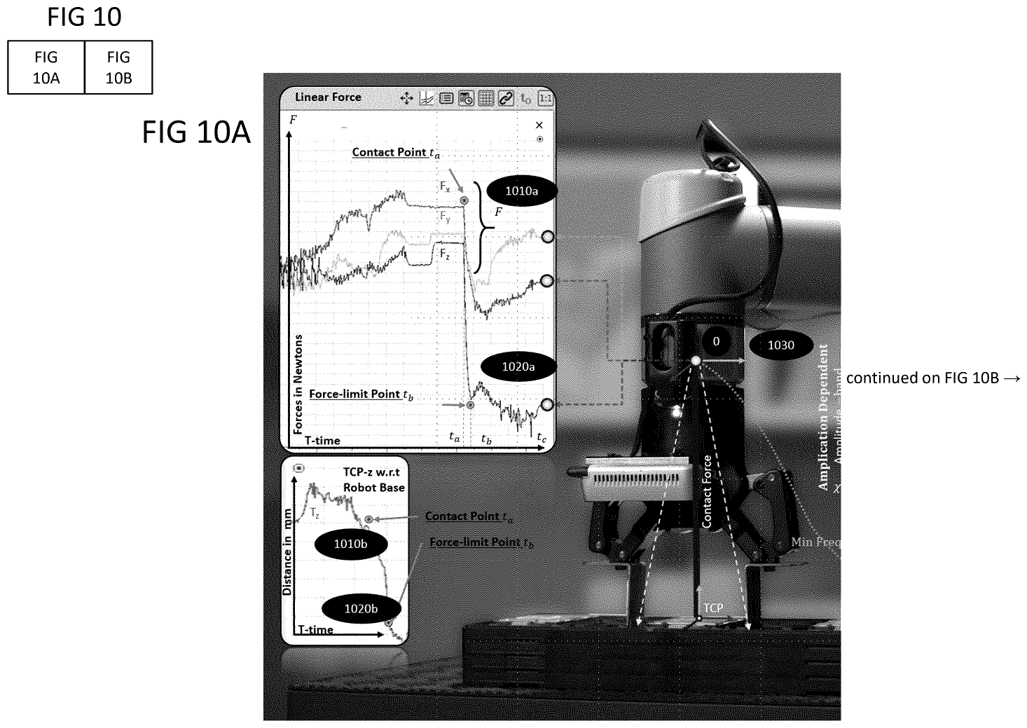

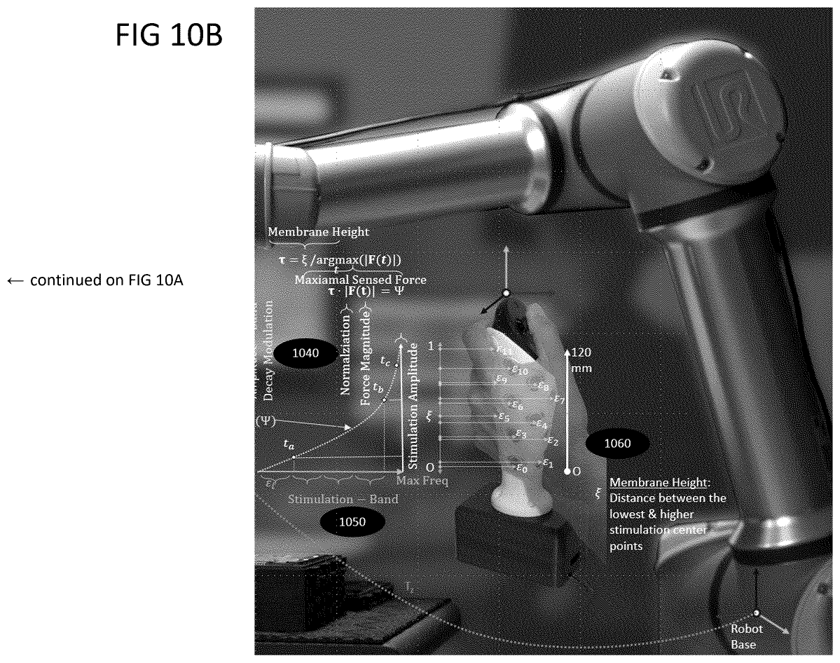

FIG. 10 (divided across two sheets labeled as FIGS. 10A-10B, respectively) illustrates a schematic diagram of teleoperation haptic stimulation 1000 or force and contact in accordance with aspects of the disclosure.

The system provides haptic feedback from the robot to the human operator during tasks such as inserting or removing electronic components in trays and assemblies. Linear forces sensed at the robot's wrist (location 0) are mapped to the membrane on the handheld controller 200, with the force magnitude and location (end-effector contact height) appropriately scaled. The upper graph shows forces separated by component, identifying the moment of contact 1010a in terms of forces and relative distances 1010b. As the user presses the component downward, the reciprocal force increases, represented as negative values due to orientation. When the component reaches the bottom of the tray 1020a, the forces transition into noisy vibrations, signaling the user to begin retreating and complete the insertion process.

The maximum expected force on the wrist is task-dependent, and a maximal threshold is determined through a series of tests 1030 and compliance with safety standards. This maximum is used to normalize the displacement mapping along the hand-held controller 200's stimulation length via scaling 1040. Amplitude modulation, an independent variable of a band modulation profile 1050, is both task and user-tunable, allowing for customized amplitude levels to select frequency bands. These bands are depicted in FIG. 8B at 810 and 812. This formulation enables the real-time definition of amplitude and frequency bands for each LRA unit location across the membrane with minimal computational overhead.

The system employs efficient and semi-continuous mapping, leveraging a discrete number of bands to ensure latency remains below the control-loop frequency (125-250 Hz in uR5-cobots). This allows human operators to rapidly and easily adapt their motions without relying on visual or auditory cues. The ability to provide real-time, responsive haptic feedback for the use of collaborative robots (cobots) in virtual reality (VR) remote operations enhances the operator's precision and efficiency in demanding tasks.

### IV. AI Stimulation in Handheld Controller (Further Details Related to FIG. 4B Described Above)

The process of transferring knowledge gained in simulation to real-world applications, known as Sim-2-Real, is an aspect of this disclosure. This approach is used to generate stimulation patterns via the amplitude εᵢ(t). Specifically, Artificial Neural Networks (ANNs) can be trained on synthetic data to integrate the dynamic states of the robot, task, and each handheld controller 200, enabling the production of vibration patterns that correspond to the combined states of the robot, human, and task.

These ANNs take an input vector comprising cues that partially or fully represent the states of the human operator, robot, and task. Input channels include the following: (A) the state of the human's right-hand handheld controller, which encompasses 6D pose, 6D velocities, a 5D one-hot encoding of buttons, a 2D joystick/pad input, and a 1D trigger input; (B) the state of the left-hand handheld controller, similarly described by the same input dimensions; (C) the state of the human's head-mounted display, captured through its 6D pose and 6D velocities; (D) robot online data, including 6-7 DoF joint angles, velocities, and accelerations, 6D force-torque measurements at the end-effector, and 2-64D tactile images from the gripper; (E) robot offline data, including of a lookup table or DNN that maps any in-range 6-7 joint configuration to a normalized reachability index (ranging from zero, for non-reachable points, to one, indicating maximal force and full 6D coverage in task space at the end-effector); (F) offline task cues, which can range from no input (e.g., when using vibration feedback to assess tool placement feasibility via the HHC) to complex inputs such as large vectors, JSON objects, or behavioral tree specifications, all serving as viable inputs for task specification within the ANN; and (G) online task cues, represented as vectors describing the runtime state of the behavioral tree or an embedding of the task state, encoded as either one-hot vectors or the result of Doc-to-Vec transformations.

This comprehensive input structure enables the ANN to produce precise, adaptive vibration feedback.

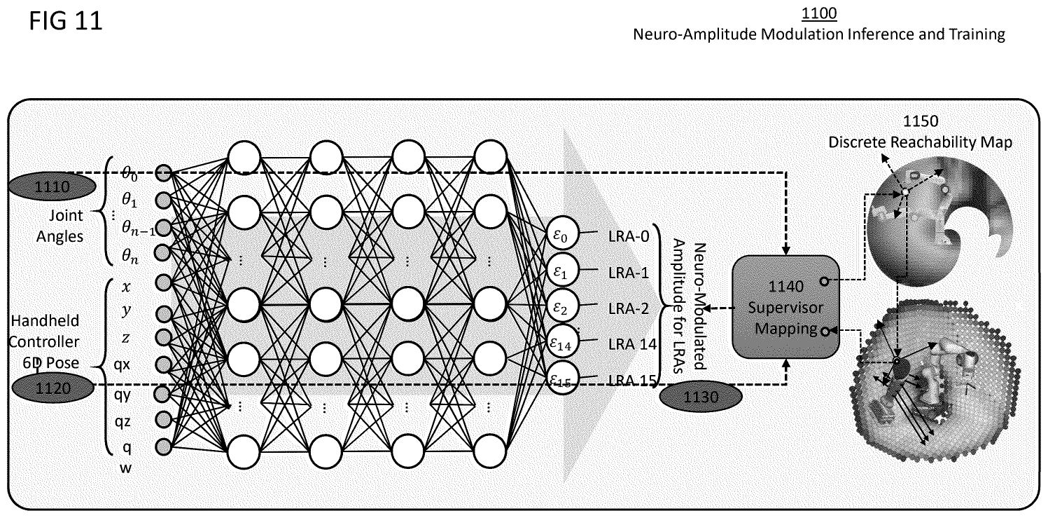

FIG. 11 illustrates a schematic diagram of neuro-amplitude modulation inference and training 1100 in accordance with aspects of the disclosure.

This figure depicts one of the multiple topologies that can be employed to relate specific signals to vibration stimulation in real time. FIG. 4C provides examples of this type of Artificial Neural Network (ANN). Each ANN is associated with a specific task (e.g., pick-and-place, polishing, drilling, wiping), which determines the input signals and features to the ANN. The output is a vector describing the amplitudes (εᵢ) of the stimuli.

This example demonstrates the connection between a reachability map (a lookup table mapping robot joint angles 1110 to indices of robot actionability at the corresponding end-effector via associated direct kinematics) and a handheld controller 200. As the user moves the handheld controller 200 within the robot's reachable workspace, the position and orientation of each LRA unit 110 on the handheld controller 200 are mapped into the robot space at the same location.

The arrows on the right indicate that graspability is mapped to an amplitude value 1130 within the supervisor mapping 1140. Normalization with respect to each εᵢ and the maximal graspability for the supervisor mapping task is part of the training. This normalization is included because the ANN must approximate a highly non-linear graspability function based on a collection of discrete samples.

In summary, the ANN learns to map a coarsely sampled function in 6/7 degrees of freedom of the robot, combining it with the cartesian six-dimensional hand pose 1120 to expand that 12/13D information into a 16D stimulation vector. This can be achieved using a multi-layer perceptron (MLP) with two three hidden layers, enabling low-latency inference.

This training approach is self-supervised, meaning that data creation and annotation are automated without human intervention. FIG. 11 illustrates a specific implementation. In this model, input data for the handheld controller is simulated using a non-uniform grid with resolutions of 4, 2, 1, and 0.5 cm. These four levels are represented as an octree, and the distribution of voxels (center points used in training) is computed from the iso-reactivity contours of the robot's reachability map. The iso-density values are set to 0.1, 0.25, 0.5, and 0.75, respectively, allowing for a higher sampling rate in areas where finer manipulation is required.

For each voxel, a set of orientations is generated for the handheld controller 200 to simulate different orientations at each position. These orientation quaternions are not sampled randomly but are selected from a set of human-feasible orientations relative to the Z-axis of the robot base, which represents the gravity vector. This ensures that the ANN focuses on orientations likely to be queried during inference, reducing the learning burden.

Using the simulated inputs, the corresponding outputs are computed as shown in FIG. 11. These two elements enable offline learning, with a regression loss function tailored to the manageable dimensions of the input and output spaces. This approach is computationally efficient, as training is performed only once per robot model and can be used for both hands, delivering significant value for real-world applications.

### V. Physical Grounded Interface for XR Robotics (Further Details Related to FIG. 4C Described Above)

Current robotic frameworks, such as the Robot Operating System (ROS), lack standardized definitions, algorithms, interfaces, and tools to facilitate natural human-robot interaction. The disclosed aspects address this human-robot interface gap by developing an extensible architecture supporting both contactless and contact-based modes of interaction through advanced haptic feedback. This architecture transitions from traditional graphical user interfaces (GUIs) to XR-physically grounded interfaces (XR-PGI) using bidirectional tactile-haptic feedback. The disclosed aspects significantly improve the intuitiveness and effectiveness of human-robot collaboration, driving advancements in cobot automation across industries through natural XR interfaces and demonstration-based programming.

FIG. 4C illustrates the management of subtasks such as “pick-and-place” 442 or “insert” in an assembly process 444. These tasks are encoded as pairs of behavioral trees and Deep Neural Networks (DNNs), each with fixed output dimensions corresponding to the number of tactors used for amplitude modulation at each contact point. This configuration enables a high-level task planner to decompose complex processes into smaller, manageable subtasks and map robot-and-task-specific actions (illustrated in FIG. 5) to stimulation patterns in the membrane (depicted in FIGS. 2A and 2C). A feature of this system is its capability to generate specific stimulation outputs and pressure inputs for each subtask using a configuration file, such as a YAML or launch file, integrated with the ROS (Robot Operating System) infrastructure. This design allows the LRA membrane's input and output to be dynamically remapped in real time whenever the robot switches modes or subtasks. The configuration YAML or launch file provides the reference for this dynamic mapping. Mode changes can also be communicated to the user through visual cues in extended reality (XR) environments or via distinctive vibration signals, ensuring intuitive user feedback. Furthermore, this framework dynamically spawns DNNs associated with state transitions to provide haptic feedback.

### A. Applications

### 1. Programming by Demonstration

In manufacturing, many High-Mix Low-Volume (HMLV) tasks have dynamic adaptability. For such tasks, human teleoperation of robots is used to program sequences of actions. An example in semiconductor manufacturing is memory matrix testing, where technicians prepare multiple testing motherboards configured with specific memory DIMMs. This process demands delicate handling, involving precise insertions and removals of DIMM modules to prevent equipment damage.

Haptic feedback plays a role in such tasks, as it allows operators to detect contact points, guide actions, and validate sub-action success or identify issues. Conveying force feedback with high fidelity and low latency is useful for these operations. For instance, during memory insertion, the forces sensed by the robot's end effector can be translated into activation patterns for linear resonant actuators (LRAs). These patterns might vary axially to represent torques or linearly to convey direct forces, enabling the human operator to execute precise control over the robot's applied forces.

Additionally, the human grip force sensed by the LRAs can dynamically adjust robot controller parameters, such as joint stiffness or force limits. For example, tightening the grip on the handheld device could increase the force limit the robot applies to a surface, while loosening the grip enables lighter physical interactions with the environment. Such fine-grained haptic feedback and control mechanisms enhance the efficiency and accuracy of HMLV tasks requiring careful force application and component manipulation

### 2. Robot-Cell Setup

When designing a robot setup, several factors regarding the placement of robots and tools are considered to ensure sufficient manipulability. These aspects can be modeled offline and optimized using gradient and grid-based methods. While effective, this approach may take several hours to configure and produce actionable results.

For scenarios where cobots perform quick tasks with small batch sizes, the time and effort to fully compose the scene may outweigh the benefits. To address this, an Artificial Neural Network (ANN) can be leveraged to enhance efficiency. Users can visualize potential robot placements in Virtual Reality (VR), directly manipulate the end-effector to test hypothesized tool locations, and evaluate their feasibility through real-time interactions. This process enables users to define trajectories and account for vibrational margins in cuspidal regions, optimizing the exploitation of reachability maps for rapid and direct deployment.

This functionality will be integrated into XR robot applications as an online deployment mode, facilitating faster setup and improved usability for dynamic and small-scale tasks.

### 3. Employee Training

The aspects disclosed herein can be utilized for training new employees in assembly tasks through Virtual Reality (VR). Trainees learn to position components in a specific sequence while adhering to constraints designed to prevent damage, ensure safety, and maintain ergonomic practices.

In a virtual training environment, the system can provide real-time feedback to guide users. For instance, localized vibrations can indicate the distance from the correct position (ground truth) and the direction of the error. By interpreting these vibrations, trainees can adjust their movements accordingly-moving in the opposite direction of the error to reach the setpoint. This interactive feedback mechanism enhances learning by enabling precise corrections and reinforcing proper techniques.

### 4. Immersive Mobile-Robot Teleoperation

For robot navigation, users requiring assistance to locate specific goals within an unfamiliar building can benefit from directional guidance through a vibration-based feedback system. For example, an inspection robot equipped with a haptic handle can guide the user to a designated area or machine.

The system dynamically maps the state of the environment, including humans, carts, and other non-stationary entities, into haptic feedback covering a full 360-degree field of awareness. Vibration amplitude corresponds to proximity, while frequency represents the estimated size or volume of detected objects. This approach enables users to plan their movements effectively, maintaining spatial awareness of nearby agents without diverting visual attention from tasks such as manipulation or inspection.

The disclosed technology enables a broad spectrum of users to develop advanced robotic automation programs incorporating vision-force parameterizations. By reducing the dependency on deep robotics expertise, this approach significantly lowers costs, accelerates deployment timelines, and improves the adaptability of manufacturing processes.

The integration of dual haptic feedback technology facilitates an enhanced level of telepresence. This capability enables precise and intuitive remote control of robots and automation systems, offering improved system troubleshooting and operational efficiency.

As humanoid robotic technologies advance toward commercial readiness, the aspects of the disclosure will reduce the costs associated with qualitative data collection. Leveraging multimodal sensory cues, such as force, torque, torsion, and haptic feedback, enables more efficient and scalable data acquisition processes.

Further, the disclosed aspects support cost-effective expansion accessories and immersive experiences in the extended reality (XR) space. These advancements cater to diverse applications, including gaming, simulations, tools, instrumentation, art, and entertainment. The versatility of this approach enhances user engagement and broadens market accessibility, making advanced XR solutions available to a wider audience.

The techniques of this disclosure may also be described in the following examples.

Example 1. A bidirectional haptic feedback system, comprising: a flexible membrane configured to be mounted on a handheld controller; sensor-actuator units arranged on the flexible membrane, the sensor-actuator units respectively including a damping mechanism configured to mechanically isolate vibrations between adjacent sensor-actuator units; a control system configured to: generate vibration signals within selected frequency bands within a proximity to a natural resonant frequency range of the sensor-actuator units to drive the actuators of the sensor-actuator units to deliver haptic feedback to a user based on a state of a robot; simultaneously detect user grasp contact and pressure through analysis of back electromotive force (EMF) signals generated by the sensor-actuator units; and adjust robot control parameters dynamically in response to the detected grasp contact and pressure.

Example 2. The bidirectional haptic feedback system of example 1, wherein the damping mechanism comprises a multi-point contact decoupling mounting structure configured to reduce transmission of vibrations between adjacent sensor-actuator units.

Example 3. The bidirectional haptic feedback system of one or more of examples 1-2, wherein the sensor-actuator units are arranged on the flexible membrane according to a mechanoreceptor pattern in a human hand.

Example 4. The bidirectional haptic feedback system of one or more of examples 1-3, wherein the control system is configured to: receive robot measurement data comprising one or more quantities measured or inferred by the robot; select a task-specific mapping based on a state of a behavioral tree associated with a robotic task; and generate the haptic feedback by mapping the robot measurement data to vibration patterns using the selected task-specific mapping.

Example 5. The bidirectional haptic feedback system of example 4, wherein: the task-specific mapping includes a linear mapping, a non-linear mapping, or a neural network trained for a specific robotic subtask, the control system is configured to dynamically switch between different task-specific mappings as the state of the behavioral tree evolves during task execution, and each task-specific mapping is configured to map its corresponding robot measurement data to unique vibration patterns that convey task-relevant robot states to the user.

Example 6. The bidirectional haptic feedback system of one or more of examples 1-5, wherein the control system is configured to provide the haptic feedback based on the state of the robot for a contactless quantity measured by the robot, wherein the contactless quantity comprises kinetic energy, payload, proximity to a joint limit, graspability, or manipulability.

Example 7. The bidirectional haptic feedback system of one or more of examples 1-6, wherein the control system is configured to generate the haptic feedback indicating a robot workspace limit or proximity to kinematic singularities.

Example 8. The bidirectional haptic feedback system of one or more of examples 1-7, wherein the damping mechanism comprises: a multi-point contact decoupling mounting structure formed of flexible material, wherein the multi-point contact decoupling mounting structure is configured to reduce transmission of mechanical vibration energy between adjacent sensor-actuator units while maintaining the sensor-actuator units in fixed positions.

Example 9. The bidirectional haptic feedback system of example 8, wherein the multi-point contact decoupling mounting structure comprises three flexible segments each arranged in a form of an S-shape.

Example 10. The bidirectional haptic feedback system of one or more of examples 1-9, wherein the flexible membrane is adaptable to a plurality of handheld controller physical forms.

Example 11. The bidirectional haptic feedback system of one or more of examples 1-10, wherein the control system is configured to: generate a set of harmonic stimulation functions having discrete frequencies separated by frequency margins within a resonant frequency band of the sensor-actuator units; modulate amplitudes of the harmonic stimulation functions to create vibration patterns for driving the sensor-actuator units; and analyze a spectral density of back EMF signals from the sensor-actuator units to identify modal peaks corresponding to the discrete frequencies, wherein shifts in the modal peaks indicate contact states and pressure levels from the user.

Example 12. The bidirectional haptic feedback system of example 11, wherein the control system is configured to: compare the modal peaks to calibration reference signals to determine attenuation ratios indicating the contact states and pressure levels.

Example 13. The bidirectional haptic feedback system of example 11, wherein: the harmonic stimulation functions comprise sine waves separated by frequency margins to enable detection of the modal peaks in the spectral density for measuring and asserting contact and pressure by the user.

Example 14. The bidirectional haptic feedback system of one or more of examples 1-13, wherein the control system comprises: a neural network configured to: receive as input data robot state data and handheld controller state data with respect to a base of the robot; generate amplitude values for driving the sensor-actuator units based on mapping the input data to a robot model; and normalize the amplitude values based on task parameters, wherein the neural network is configured to be trained using simulated input data distributed according to robot operational parameters.

Example 15. The bidirectional haptic feedback system of one or more of examples 1-14, wherein the control system is configured to: store a plurality of mapping functions associated with different robotic subtasks, wherein the mapping functions include linear mappings, nonlinear mappings, or neural networks; dynamically select and apply a mapping function from the plurality of mapping functions based on a current robotic subtask state; and map robot states and sensor inputs to haptic feedback patterns using the selected mapping function.

Example 16. A component of a bidirectional haptic feedback system, comprising: processor circuitry; and a non-transitory computer-readable storage medium including instructions that, when executed by the processor circuitry, cause the processor circuitry to: generate vibration signals within selected frequency bands within a proximity to a natural resonant frequency range of sensor-actuator units arranged on a flexible membrane mounted on a handheld controller, the sensor-actuator units respectively including a damping mechanism configured to mechanically isolate vibrations between adjacent sensor-actuator units, wherein the vibration signals drive the actuators of the sensor-actuators units to deliver haptic feedback to a user based on a state of a robot; simultaneously detect user grasp contact and pressure through analysis of back electromotive force (EMF) signals generated by the sensor-actuator units; and adjust robot control parameters dynamically in response to the detected grasp contact and pressure.

Example 17. The component of example 16, wherein the instructions further cause the processor circuitry to: receive robot measurement data comprising one or more quantities measured or inferred by the robot; select a task-specific mapping based on a state of a behavioral tree associated with a robotic task; and generate the haptic feedback by mapping the robot measurement data to vibration patterns using the selected task-specific mapping.

Example 18. The component of example 17, wherein: the task-specific mapping includes a linear mapping, a non-linear mapping, or a neural network trained for a specific robotic subtask, the instructions further cause the processor circuitry to dynamically switch between different task-specific mappings as the state of the behavioral tree evolves during task execution, and each task-specific mapping is configured to map its corresponding robot measurement data to unique vibration patterns that convey task-relevant robot states to the user.

Example 19. The component of one or more of examples 16-18, wherein the instructions further cause the processor circuitry to: generate a set of harmonic stimulation functions having discrete frequencies separated by frequency margins within a resonant frequency band of the sensor-actuator units; modulate amplitudes of the harmonic stimulation functions to create vibration patterns for driving the sensor-actuator units; and analyze a spectral density of back EMF signals from the sensor-actuator units to identify modal peaks corresponding to the discrete frequencies, wherein shifts in the modal peaks indicate contact states and pressure levels from the user.

Example 20. The component of example 19, wherein the instructions further cause the processor circuitry to: compare the modal peaks to calibration reference signals to determine attenuation ratios indicating the contact states and pressure levels.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A bidirectional haptic feedback system, comprising:
a flexible membrane configured to be mounted on a handheld controller;
sensor-actuator units arranged on the flexible membrane, the sensor-actuator units respectively including a damping mechanism configured to mechanically isolate vibrations between adjacent sensor-actuator units;
a control system configured to:
generate vibration signals within selected frequency bands within a proximity to a natural resonant frequency range of the sensor-actuator units to drive the actuators of the sensor-actuator units to deliver haptic feedback to a user based on a state of a robot;
simultaneously detect user grasp contact and pressure through analysis of back electromotive force (EMF) signals generated by the sensor-actuator units; and
adjust robot control parameters dynamically in response to the detected grasp contact and pressure.

2. The bidirectional haptic feedback system of claim 1, wherein the damping mechanism comprises a multi-point contact decoupling mounting structure configured to reduce transmission of vibrations between adjacent sensor-actuator units.

3. The bidirectional haptic feedback system of claim 1, wherein the sensor-actuator units are arranged on the flexible membrane according to a mechanoreceptor pattern in a human hand.

4. The bidirectional haptic feedback system of claim 1, wherein the control system is configured to:
receive robot measurement data comprising one or more quantities measured or inferred by the robot;
select a task-specific mapping based on a state of a behavioral tree associated with a robotic task; and
generate the haptic feedback by mapping the robot measurement data to vibration patterns using the selected task-specific mapping.

5. The bidirectional haptic feedback system of claim 4, wherein:
the task-specific mapping includes a linear mapping, a non-linear mapping, or a neural network trained for a specific robotic subtask,
the control system is configured to dynamically switch between different task-specific mappings as the state of the behavioral tree evolves during task execution, and
each task-specific mapping is configured to map its corresponding robot measurement data to unique vibration patterns that convey task-relevant robot states to the user.

6. The bidirectional haptic feedback system of claim 1, wherein the control system is configured to provide the haptic feedback based on the state of the robot for a contactless quantity measured by the robot, wherein the contactless quantity comprises kinetic energy, payload, proximity to a joint limit, graspability, or manipulability.

7. The bidirectional haptic feedback system of claim 1, wherein the control system is configured to generate the haptic feedback indicating a robot workspace limit or proximity to kinematic singularities.

8. The bidirectional haptic feedback system of claim 1, wherein the damping mechanism comprises:
a multi-point contact decoupling mounting structure formed of flexible material,
wherein the multi-point contact decoupling mounting structure is configured to reduce transmission of mechanical vibration energy between adjacent sensor-actuator units while maintaining the sensor-actuator units in fixed positions.

9. The bidirectional haptic feedback system of claim 8, wherein the multi-point contact decoupling mounting structure comprises three flexible segments each arranged in a form of an S-shape.

10. The bidirectional haptic feedback system of claim 1, wherein the flexible membrane is adaptable to a plurality of handheld controller physical forms.

11. The bidirectional haptic feedback system of claim 1, wherein the control system is configured to:
generate a set of harmonic stimulation functions having discrete frequencies separated by frequency margins within a resonant frequency band of the sensor-actuator units;
modulate amplitudes of the harmonic stimulation functions to create vibration patterns for driving the sensor-actuator units; and
analyze a spectral density of back EMF signals from the sensor-actuator units to identify modal peaks corresponding to the discrete frequencies, wherein shifts in the modal peaks indicate contact states and pressure levels from the user.

12. The bidirectional haptic feedback system of claim 11, wherein the control system is configured to:
compare the modal peaks to calibration reference signals to determine attenuation ratios indicating the contact states and pressure levels.

13. The bidirectional haptic feedback system of claim 11, wherein:
the harmonic stimulation functions comprise sine waves separated by frequency margins to enable detection of the modal peaks in the spectral density for measuring and asserting contact and pressure by the user.

14. The bidirectional haptic feedback system of claim 1, wherein the control system comprises:
a neural network configured to:
receive as input data robot state data and handheld controller state data with respect to a base of the robot;
generate amplitude values for driving the sensor-actuator units based on mapping the input data to a robot model; and
normalize the amplitude values based on task parameters,
wherein the neural network is configured to be trained using simulated input data distributed according to robot operational parameters.

15. The bidirectional haptic feedback system of claim 1, wherein the control system is configured to:
store a plurality of mapping functions associated with different robotic subtasks, wherein the mapping functions include linear mappings, nonlinear mappings, or neural networks;
dynamically select and apply a mapping function from the plurality of mapping functions based on a current robotic subtask state; and
map robot states and sensor inputs to haptic feedback patterns using the selected mapping function.

16. A component of a bidirectional haptic feedback system, comprising:
processor circuitry; and
a non-transitory computer-readable storage medium including instructions that, when executed by the processor circuitry, cause the processor circuitry to:
generate vibration signals within selected frequency bands within a proximity to a natural resonant frequency range of sensor-actuator units arranged on a flexible membrane mounted on a handheld controller, the sensor-actuator units respectively including a damping mechanism configured to mechanically isolate vibrations between adjacent sensor-actuator units, wherein the vibration signals drive the actuators of the sensor-actuators units to deliver haptic feedback to a user based on a state of a robot;
simultaneously detect user grasp contact and pressure through analysis of back electromotive force (EMF) signals generated by the sensor-actuator units; and
adjust robot control parameters dynamically in response to the detected grasp contact and pressure.

17. The component of claim 16, wherein the instructions further cause the processor circuitry to:
receive robot measurement data comprising one or more quantities measured or inferred by the robot;
select a task-specific mapping based on a state of a behavioral tree associated with a robotic task; and
generate the haptic feedback by mapping the robot measurement data to vibration patterns using the selected task-specific mapping.

18. The component of claim 17, wherein:
the task-specific mapping includes a linear mapping, a non-linear mapping, or a neural network trained for a specific robotic subtask,
the instructions further cause the processor circuitry to dynamically switch between different task-specific mappings as the state of the behavioral tree evolves during task execution, and
each task-specific mapping is configured to map its corresponding robot measurement data to unique vibration patterns that convey task-relevant robot states to the user.

19. The component of claim 16, wherein the instructions further cause the processor circuitry to:
generate a set of harmonic stimulation functions having discrete frequencies separated by frequency margins within a resonant frequency band of the sensor-actuator units;
modulate amplitudes of the harmonic stimulation functions to create vibration patterns for driving the sensor-actuator units; and
analyze a spectral density of back EMF signals from the sensor-actuator units to identify modal peaks corresponding to the discrete frequencies, wherein shifts in the modal peaks indicate contact states and pressure levels from the user.

20. The component of claim 19, wherein the instructions further cause the processor circuitry to:
compare the modal peaks to calibration reference signals to determine attenuation ratios indicating the contact states and pressure levels.
